(19) United States
(12) Patent Application Publication
(10) Pub. No.: US 2024/0354850 A1
(43) Pub. Date: Oct. 24, 2024

(54) SYSTEM AND METHOD FOR DYNAMIC DATA PACKAGE TRANSMISSION ON A DIGITAL LEDGER

(71) Applicant: Loop Commerce, Inc., Stamford, CT (US)

(72) Inventor: Gabriel Saunkeah, Stamford, CT (US)

(21) Appl. No.: 18/634,329

(22) Filed: Apr. 12, 2024

Related U.S. Application Data
(60) Provisional application No. 63/497,293, filed on Apr. 20, 2023.

(51) Int. Cl. G06Q 40/04

(52) U.S. Cl. CPC G06Q 40/04; G06Q 2220/00

(57) ABSTRACT

Methods are described herein for transmitting digital objects between devices through a digital ledger. A computing device may maintain a digital ledger containing a plurality of allocation nodes. The computing device may execute an exchange between a first and second allocation node. The first and second allocation nodes may be associated with a first and second user device, respectively. The first allocation node may transfer ownership of a package of data to the second allocation node. The computing device may generate one or more data factors by comparing the package of data to an individual data bundle of the second user device. Finally, the computer device may generate a modified package of data by applying the data factors to the package of data.

### CROSS-REFERENCE TO RELATED APPLICATIONS

The present patent application claims the benefit of priority to U.S. Provisional Patent Application 63/497,293 filed Apr. 20, 2023, which is incorporated herein by reference in its entirety for all purposes.

### TECHNICAL FIELD

This disclosure relates generally to data transmission systems or methods, and more particularly to dynamic data package transmission on a digital ledger.

### BACKGROUND

Transmission of certain digital objects is typically achieved through a standard data-transmission process: transmitting directly from a first user device to a second user device, a third party (e.g., terminal device associated with a place of business, a retail store, a restaurant, or the like) to a user device, or similar. In a typical operation, the transaction is straightforward with no tolerance for variation by either user device. The first user device, second user device, or third party are not able to alter, combine, or often times re-distribute the digital object. In addition, the digital objects may include features that restrict access to the digital object to single system (e.g., the system that assigns the digital object, etc.), which is typically associated with a third party, thus limiting use possibilities. For example, the value associated with the digital object may not be abstracted and applied to different systems. The restricted use and transmission of digital objects render digital objects inflexible, inefficient, subject to fraud, and waste.

### SUMMARY

Methods are described herein for transmitting digital objects between devices through a digital ledger. The method comprises: maintaining a digital ledger containing a plurality of allocation nodes; executing an exchange between a first allocation node and a second allocation node, wherein the first allocation node transfers ownership of a package of data to the second allocation node, and wherein the first allocation node is associated with a first user device and wherein the second allocation node is associated with a second user device; generating one or more data factors, wherein generating the one or more data factors includes comparing the package of data to an individual data bundle of the second user device; and generating a modified package of data, wherein generating a modified package of data includes applying the data factors to the package of data.

Systems are described herein for transmitting digital objects between devices through a digital ledger. The systems include one or more processors and a non-transitory computer-readable storage medium storing instructions that, when executing by the one or more processors, cause the one or more processors to perform any of the methods as previously described.

A non-transitory computer-readable medium described herein may store instructions which, when executed by one or more processors, cause the one or more processors to perform any of the methods as previously described.

These illustrative examples are mentioned not to limit or define the disclosure, but to aid understanding thereof. Additional embodiments are discussed in the Detailed Description, and further description is provided there.

### BRIEF DESCRIPTION OF THE DRAWINGS

Features, instances, and advantages of the present disclosure are better understood when the following Detailed Description is read with reference to the accompanying drawings.

FIG. 1 illustrates an example system of a package of data or digital object transmitted from one user device to another using a digital ledger server according to aspects of the present disclosure.

FIG. 2 illustrates an example computer device configured to conduct machine-learning modeling and training according to aspects of the present disclosure.

FIG. 3 illustrates an example system configured to personalize a package of data for a particular user according to aspects of the present disclosure.

FIG. 4 illustrates an example system configured to execute a personalization process using internal and external data according to aspects of the present disclosure within creation block 116.

FIG. 5 illustrates a flowchart of an example process for generating a modified package of data according to aspects of the present disclosure.

FIG. 6 illustrates an example computing device according to aspects of the present disclosure.

### DETAILED DESCRIPTION

Various instances of the disclosure are discussed in detail below. While specific implementations are discussed, it should be understood that this is done for illustration purposes only. A person skilled in the relevant art will recognize that other components and configurations may be used without parting from the spirit and scope of the disclosure.

In some implementations, digital objects may be non-fungible software objects that represent real-world objects or services associated with a third-party entity. Digital objects may be a virtual abstraction of collectibles, tangible products, tangible objects, services, any combination thereof, or the like provided by one or more third-party entities. Digital objects may be associated with a value that may fluctuate over a duration of time, and may be associated with a third-party entity, a fiat currency, and/or another instrument of value. Digital objects are typically transmitted directly from a first user device to a second user device, from a terminal device (e.g., a third party such as a business, retail store, restaurant, or the like) to a user device, or similar. In a typical operation, the transaction can be straightforward with no tolerance for variation by either user device. The first user device, second user device, or terminal device are not able to alter, combine, or often times re-distribute the digital object. For example, a user device could obtain a non-fungible object and forward that non-fungible object to another user device using an online messaging system (e.g., email, text, etc.). However, these digital objects are inflexible, open to fraud, inefficient, and can create waste. For example, if the first user device receives a digital object associated with a specific retailer and that retailer permanently closes in the meantime, then the individual will be unable to use the digital object and, further, the individual may not have any recourse.

Accordingly, the digital ledger server disclosed herein addresses the aforementioned issues by operating a system and method for transmitting dynamic digital objects using a digital ledger. More specifically, the present disclosure includes systems and methods for modifying, tracking, and personalizing digital objects according to a series of data factors. In some instances, a digital object can be acquired by a first user device and sent to a second user device through the digital ledger server, which manages the digital ledger. The digital ledger server can facilitate an exchange of data associated with the digital object between a first user device and a second user device. For example, the digital ledger server can receive a package of data that defines the digital object from the first user device and output a modified package of data to the second user device that corresponds to a transformed version of the digital object. The package of data may be modified based on one or more data factors, which may add, remove, or modify properties of the digital object. The exchange of data associated with the digital object between a first user device and a second user (e.g., referred to herein as a transaction) may be recorded on a digital ledger within the digital ledger server.

The digital ledger server improves the flexibility of digital objects and reduces wasted digital objects by modifying the package of data associated with the digital object according to particular criteria of a user device, which may increase a likelihood that the digital object may be utilized. For example, if a user device receives multiple digital objects issued by a same terminal device, the digital ledger server may combine the value associated with the multiple digital objects into a new value. The new value may be the sum of the values associated with the multiple digital objects or may be determined using a different method. Additionally, the digital ledger itself can prevent fraud within digital object transactions by recording all transactions and encrypting them, which may prevent unauthorized access to the digital object. Each node of the digital ledger may correspond to a digital object that may selectively absorb the properties of user devices associated with the current node and previous nodes according to external or internal factors, which may increase the use of the digital object, while preventing unauthorized devices from accessing the digital objects.

A transaction can be completed between a first user device and a second user device. In some instances, a transaction process can be initiated when the first user device receives a notification from the digital ledger server that indicates that a digital object has been received. Alternatively, a digital object associated with the first user device may be registered with the digital ledger server, which may bind the digital object to the first user device. The generation or receipt of a digital object by the first user device may be recorded within a digital ledger via a first allocation node. The first allocation node may include an identification of the digital object, and dentification of a source of the digital object (e.g., the third party that assigned or issued the digital object, etc.), an identification of the device to which the digital object is assigned (e.g., the first user device in this example), properties of the digital object, and/or the like. The first user device can store a reference to the digital object in a digital wallet within local memory. Along with the reference to the digital object, the first user device may store additional information such as, but not limited to, an encryption key that allows the first user device to access the digital object within the digital ledger, information pertaining to the third party the digital object is associated with, the source of the digital object, a copy of a portion of the digital ledger associated with the digital object (e.g., such as the one or more allocation nodes associated with the digital object and an identification of the relationships between the allocation nodes, etc.), combinations thereof, or the like.

The first user device can transmit a request to the digital ledger server to allocate the digital object to a second user device. The digital ledger server can gather information from internal and external sources and create a set of data factors that can be utilized to modify the digital object and create a second allocation node within the digital ledger associated with the second user device. The digital ledger may facilitate a connection between the first allocation node and the second allocation node that records the allocation of the digital object to the second user device along with any modifications to the digital object that result from the allocation. The connection may be unidirectional or bidirectional to enable identifying all devices (historical or current) associated with a particular digital object.

In some instances, the digital object can be modified during an allocation to a new device based on one or more external factors. An external factor may be a constraint or property associated with a device external from the digital ledger server that is related to the digital object. Examples of external factors include, but are not limited to, an identification of a quantity of permitted transactions involving the digital object, additional value or properties to be added to the digital object during a transaction, value or properties to be removed from the digital object during a transaction, value or properties of the digital object that are to be modified during a transaction, additional digital objects to be allocated to the first user device and/or the second user device during a transaction, combinations thereof, or the like. For example, a user device can reallocate a digital object associated with a terminal device originally allocated to the user device to another user, which may cause an increase or decrease in the value of the digital object based on the external factors provided by the terminal device.

External factors may be defined to increase or decrease a likelihood of an action being performed with respect to a digital object. For instance, a terminal device may improve a likelihood that a digital object will be redistributed by increasing a value of the digital object with each subsequent allocation of the digital object to a new user device. A terminal device may decrease the value of the digital object with each subsequent allocation of the digital object to a new user device. In some instances, a terminal device may modify the digital object to increase the likelihood of the user device completing an action. For example, a terminal device may modify a digital object associated with a user device that has accumulated four digital objects associated with that respective terminal device in a digital wallet associated with the user device. Upon receipt of the fourth digital object, the terminal device may notify the digital ledger server to modify the fourth digital object in a manner so as increase a likelihood that the action is performed (e.g., such as exchanging the digital object for an object or service associated with the terminal device, etc.). In some examples, a terminal device may improve the likelihood that a digital object will not be redistributed by allocating additional digital objects or increasing the value of the additional objects according to how long a single user device “holds” the digital object.

In some instances, digital objects may be associated with “dominant” and/or “recessive” characteristics. The dominant and recessive characteristics may be used when combining two or more digital objects to determine the characteristics of a combined digital object. In some instances, a dominant characteristic of a first type may override a recessive characteristic of a same type. For example, continuing with the example above, the fourth digital object may have a “dominant” characteristic such that when the fourth digital object is combined with the pre-existing digital objects, the new digital object may include the dominant characteristic of the fourth digital object. As another example, if a first user receives a first gift associated with a recessive characteristic and a second gift associated with a dominant characteristic, the first gift and second gift may combine into a third gift associated with the dominant characteristic that is also associated with the combined value of the first gift and the second gift. Dominant and recessive characteristics may only impact one another if they are in direct conflict (e.g., such as when the dominant and/or recessive characteristics are of a same type). In some instances, “dominant” and “recessive” may be measured terms of a control value on a sliding scale, wherein the dominance of a characteristic can be measured relative to the dominance of a second characteristic. The control value of a characteristic may be a real number on a scale from zero to one, where a value of zero may represent recessive and a value of one may represent dominant. A characteristic may be an associated third-party, a representation of a real-world object or any property thereof (e.g., such as, but not limited to size, color, a value such as a monetary value, cost, quantity, pattern, output, power, physical feature, version, etc.), a service or any property thereof, a monetary value, any combination thereof, or the like. As an illustrative example, if a first user re-gifts a digital object to a second user, the digital object may be manipulated from the first user to the second user according to the contents of a digital wallet associated with the second user.

Two distinct digital objects may both be associated with dominant characteristics and/or recessive characteristics. In some examples, if two distinct digital objects have equal control values, the digital object that is older (e.g., the digital object with an earliest origination timestamp, etc.) may override the newer digital object. Alternatively, the newer digital object may override the older digital object. For example, if a user receives a first gift associated with a dominant characteristic, then receives a second gift associated with a dominant characteristic, and these two dominant characteristics are in conflict, then the first gift and the second gift may combine into a third gift associated with the dominant characteristic associated with the first gift.

In some examples, the user device holding the digital object, the third-party that generated the digital object, the digital ledger server, etc. may select, for each characteristic associated with the digital object, whether the characteristic is dominant and/or recessive as well as the control value of the characteristic. As an illustrative example, a first digital object may be associated with a dominant characteristic of the color red and a second digital object may be associated with a recessive characteristic of the color blue. When the first digital object is combined with the second digital object, the combined digital object may be associated with the red color characteristic. Alternatively, combined digital object may be associated with a purple color characteristic, wherein the dominant and recessive characteristics combine to create a unique characteristic. As another example, the user device may input a preference for blue causing the combined digital object to be associated with the blue color characteristic. In some examples, a dominant characteristic may override other characteristics regardless of the opposing characteristic. For instance, a characteristic corresponding to an identification of a particular retailer may have a relatively high control value (i.e., almost to or equal to one) that it may override all other characteristics associated with retailers.

In some instances, the value of the digital object can change based on external pricing variations. For example, a digital object may be associated with a specific tangible object regardless of the specific tangible object's value. A value characteristic of the digital object may be adjusted to accommodate changes in value of the specific tangible object. In some examples, a combined value characteristic may vary according to an association with a specific terminal device. For example, if a first gift is associated with a particular retailer and a particular value and combines with a second gift associated with the particular retailer and a second particular value, the associated value of the combined gift may vary according to the particular retailer.

In some instances, a user device may not be configured to access or use a digital object, may not want the real-world object represented by the digital object, may want to obtain the real-world object represented by the digital object from a different third-party, etc. In those instances, the user device may combine the digital object with another digital object (generating a new digital object), transfer the digital object to a second user device, transform the digital object into another digital object that is associated with a different third-party, or the like. For instance, a digital object may be locked to a particular third-party that is physically remote from a user device or provides objects and/or services that are not of use to the user device.

A projected value of the digital object can be derived (e.g., by the user device, the digital ledger server, the third-party associated with the digital object, the second user device that may be receiving the digital object, etc.) using data associated with the digital object, including, but not limited to, the terminal device associated with the digital object, previous allocations of the digital object, the real-world object or service represented by the digital object, the third-party associated with the digital object, a location of the real-world object and/or service, locations of the third-party, duration of existence of the digital object, any combination thereof, and the like. The user device may request a reallocation of the digital object based on the projected value and the information associated with the digital object in the allocation node causing a new digital object to be generated with characteristics that may be more favorable to the user device. For example, the new digital object may be associated with a third-party that is closer to the user device or that may be preferable to a user of the user device, represent a real-world object or service that may be usable and/or preferable to the user or user device, represent a value rather than a real-world object or service, any combination thereof, or the like.

Reallocation may impact the projected value of the new digital object. For example, a digital object associated with a third party may be reallocated to be associated with a different third party, however the projected value associated with the new digital object may be impacted by an increase or decrease in overall projected value. Additionally, the reallocation to a different third party may impact the new digital object's association with tangible objects. The tangible object associated with the digital object may change during the reallocation process. Digital objects that may be unusable by the first user device may gain value based on the novelty of the digital object.

In some instances, a third party may generate and/or allocate additional digital objects in response a first digital object being allocated to a user device. For example, a user device may receive a first digital object, and in response, the third-party associated with the first digital object may generate and/or allocate a second digital object. The second digital object may be allocated from a third-party associated with the first digital object, another user device, or another entity. The second digital object may be reallocated to a second user device. The third party may determine whether to perform additional actions in response to the reallocation of the second digital object. For example, when the second digital object is reallocated, the third-party associated with the first digital object may allocate a third digital object to the first user device and/or the second user device. The third-party may generate and/or allocate additional digital objects to the first user device for each instance in which the second digital object is reallocated. The third-party may also generate and/or allocate additional digital objects to other devices that receive digital objects. For example, the third-party may generate and/or allocate additional digital objects to the second user device for each instance in which the third digital object is reallocated, etc.

In some examples, a digital object held in a digital wallet associated with a first user device may be based on one or more mutations. Mutations may be associated with a characteristic of the digital object such as, but not limited to, an associated third-party, other digital objects held in the digital wallet, external events (e.g., such as real-world events, a time interval defined by associated third-party, a current time, events associated with or triggered by the associated third-party, etc.), any combination thereof, or the like. A mutation may modify the digital object by altering the value associated with the digital object, changing an associated tangible product that is associated with the digital object, causing the digital object to expire, allocating a “gift with purchase” digital object after a duration of time, any combination thereof, or the like. Mutations may be dynamically defined (e.g., defined in real-time before or after a digital object is allocated to a digital wallet, etc.).

In some instances, the digital ledger system may modify digital objects based on internal factors, which may be particular to that respective transaction. An internal factor may be a constraint or property associated with a device within or connected to the digital ledger server. Examples of internal factors include, but are not limited to, items in the digital wallets associated with the first user device or the second user device respectively, geographic location of the first user device or the second user device, supplemental data factors generated by a machine-learning model, combinations thereof, or the like. Additionally, internal factors may be extracted from intrinsic characteristics of the digital object itself. The digital ledger may modify digital objects to reduce the quantity of nodes within the digital ledger, reduce duplicity, and/or decrease waste. For example, if the digital wallet associated with the second user device includes references to a pre-existing digital object associated with a terminal device, any additional digital objects allocated to the second user device also associated with the terminal device may be merged with the pre-existing digital object to generate a unified digital object. The unified digital object may have a set of unique qualities or may take on qualities of a “dominant” discrete digital object. For another example, a user device could be allocated a digital object associated with a specific object (e.g., a video game) but, after any duration of time, be allocated a second digital object also associated with that specific object. Upon receipt of the second digital object by the user device, the digital ledger server may generate, using external and internal factors, various alternatives to the specific item to avoid duplicity within the digital wallet associated with the user device. The algorithm for digital object modification may utilize particular properties of the digital object or user device.

The digital ledger server may then transmit a notification to the second user device indicating that the digital object has been allocated to the second user device from the first user device as modified by the digital ledger server. The notification may include additional information along with the indication that the digital object has been allocated to the second user device such as, but not limited to, encryption keys usable to access the digital object or execute functions of the digital ledger on the digital object, information associated with the digital object, metadata, information associated with the first user device, information associated with the third-party and/or source of the digital object, combinations thereof, or the like. The notification and/or any information included therein may be stored in a digital wallet within local memory of the second user device. The digital ledger server may then transmit a notification to the first user device indicating a successful allocation of the digital object. The notification may cause the digital wallet of the first user device to be updated by removing the reference to the digital object and any access keys to the first allocation node of the digital ledger.

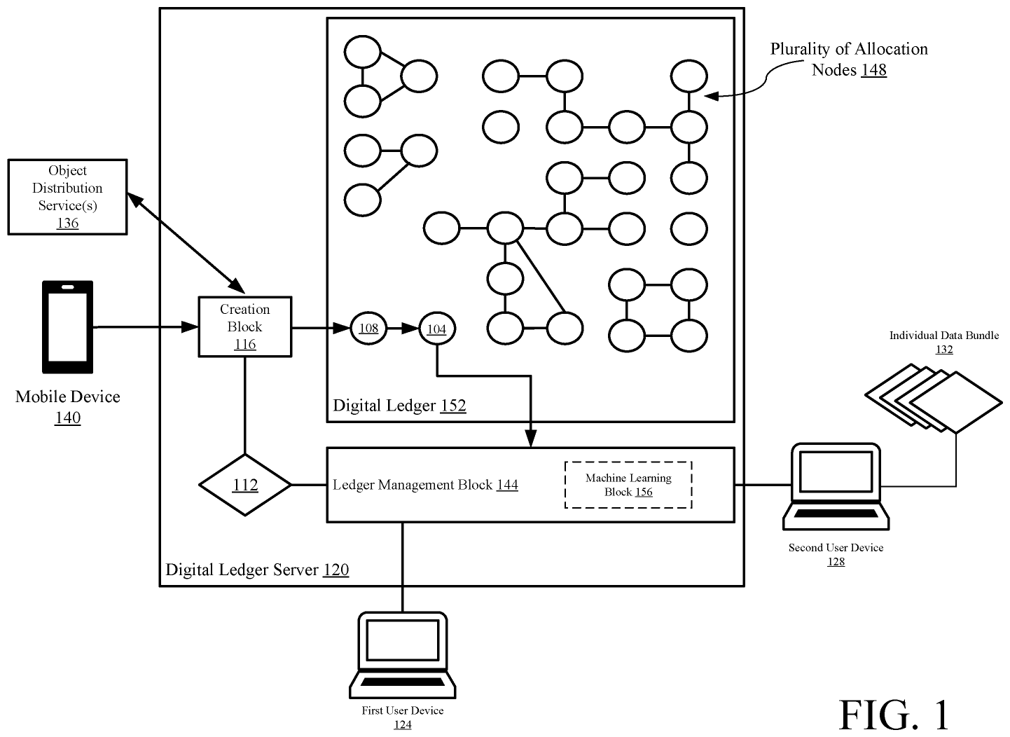

FIG. 1 illustrates an example system of a package of data or digital object transmitted from one user to another using the digital ledger server according to aspects of the present disclosure. A package of data may be associated with a digital object and/or additional, supplemental data. The package of data may contain data referencing a non-fungible object that corresponds to a real-world object or service associated with a third-party entity. Digital ledger server 120 may include digital ledger 152 configured to record and manage digital objects associated with a plurality of user devices and/or terminal devices.

Digital ledger 152 may be used to track and verify a variety of transactions or exchanges between users. Digital ledger 152 may keep a detailed account stored in local memory of all transactions occurring between users. Digital ledger 152 may record various characteristics of the transaction, including, but not limited to, the users involved in transactions, the user receiving and user sending the digital object, the time and date of the transfer, and/or the quantity of digital objects exchanged.

In some instances, digital ledger 152 may be available for examination (e.g., read only) by all users with individual allocation nodes being accessible to those user devices associated with the allocation node. In other instances, digital ledger 152 may restrict access in which each user device may have access to inspect digital ledger 152, but may see only those allocations associated with the user device. In those instances, the third-party or terminal device that generated the digital object of an allocation node may also access those allocation nodes (e.g., with read only access or read/writes access to the allocation node) such that the third-party and/or terminal device may identify user devices that are allocated digital objects issued by the third-party and/or terminal device, modifications made to the digital object, etc.

Digital ledger 152 may be managed centrally by one entity (e.g., within a server, a distributed environment, etc.) or may be managed de-centrally by one or more entities. The managing entity may ensure the validity of all transactions. The managing entity may prevent fraud by validating groups of transactions occurring during a set duration and confirming that transactions do not contradict each other. A digital ledger (e.g., digital ledger 152) maintained by a single managing entity may increase efficiency in transactions and decrease energy consumption. Additionally, the digital ledger maintained by the single managing entity may decrease the time to access digital object allocated to a particular user device. Once a transaction is validated by the managing entity, the transaction may be permanently stored on digital ledger 152.

Digital ledger 152 may be comprised of a plurality of allocation nodes 148. A node may be generated when a digital object is allocated to a user device. The nodes may contain data pertaining to the digital object exchanged on digital ledger 152, stored as a package of data. The package of data may contain data of various natures, including information pertaining to the digital object, references to a non-fungible object that corresponds to a real-world object or service, the users involved in the transaction, ownership information, qualities of the respective digital object, any combination thereof, or the like. The digital object associated with the package of data may be associated with a tangible, real-world object or service, or it may be associated with pure value (i.e., monetary value) associated with a corresponding third-party vendor or service provider (e.g., a digital gift card). In some instances, a node may not contain the digital object, only references to the digital object. In those instances, the digital object may be stored by a user device (that owns the digital object) or the terminal device or third party that generated the digital object. The data stored in the node may also be encrypted using a private or public key (associated with or stored by the user). If a user associated with a node wishes to allocate the digital object associated with the node, a new node is generated on the digital ledger and the transaction is executed.

Digital ledger 152 may be managed by a digital ledger server 120 maintained by the managing entity. Digital ledger server 120 may generate the nodes for each transaction, validate the transactions, allow for the extraction of digital object references from digital ledger 152, remove rogue transaction (e.g., and/or corresponding allocation nodes) from digital ledger 152, any combination thereof, or the like. The server may serve as an intermediary between a user and digital ledger 152.

A transaction can be executed between first user device 124 and second user device 128 that allocates a digital object of first user device 124 to second user device 128. First user device 124 and second user device 128 can be, but are not limited to, a mobile device (e.g., such as a smartphone, tablet, etc.), computer device (e.g., such as a desktop or laptop computer, server, etc.), or other device. First user device 124 and second user device 129 may be the same type of device or different type of devices. First user device 124 and second user device 128 may be connected to the digital ledger server 120 by one or more network processors (e.g., WiFi, Bluetooth, and/or other transceivers). Digital ledger server 120 may be hosted on a computing device that may contain one or more processing devices, including, but not limited to, system-on-a-chip, central processing units, application-specific integrated circuits, field programmable gate arrays, and/or the like.

First user device 124 may acquire a digital object through different means (e.g., purchasing, receiving from another user device, etc.). The digital object may be represented by allocation node 104 within the digital ledger. Allocation node 104 may include package of data 112, which represents information associated with the digital object of allocation node 104. First user device 124 can receive a notification from digital ledger server 120 that indicates that a digital object has been received. Each allocation node of digital ledger 152 may be generated by organizing the dataset to be stored in the transaction block (e.g., into a set of data, data vector, and/or the like) and encrypting the dataset using a cryptographic algorithm (e.g., such as a hash algorithm that generates a 256-bit or greater encrypted representation of the dataset). The cryptographic algorithm may contain a public key generated by a private key associated with first user device 124. The private key can be maintained in a digital wallet within local memory of first user device 124.

A private key may be comprised of a 256-bit or greater hash. A private key may be generated by the associated user device or generated by a secondary device and/or secondary algorithm. The private key is used to generate a public key with an elliptic curve digital signal algorithm (ECDSA). The public key is used to encrypt packages of data associated with an allocation node using an RSA cryptosystem. Digital ledger server 120 may use the public key associated with the user device when allocating digital objects to the user device.

The receipt of package of data 112 may be recorded within digital ledger 152 of digital ledger server 120. First user device 124 may store a reference to package of data 112 in the digital wallet associated with first user device 124. The reference to allocation node 104 may include the private key that is usable to first user device 124 to access package of data 112 and the digital object, information associated with package of data 112, an identification of a source of package of data 112, and/or the like.

First user device 124 may transmit a request to digital ledger server 120 to allocate the digital object to another system or device. For example, first user device 124 may allocate the digital object to an object distribution service in exchange for one or more objects provided by or services performed by the object distribution service or an associated device. In another example, first user device 124 may transmit a request to allocate the digital object to second user device 128.

During a registration process with digital ledger server 120, first user device 124 and second user device 128 may generate one or more private keys and for each private key, a set of public keys. The public keys (or a subset thereof) may be transmitted to digital ledger server 120 to facilitate encryption of allocation nodes, communications between a respective user device and digital ledger server 120, etc. In some instances, digital ledger server 120 may generate one or more private keys and a set of public keys (for each private key) for each device registered to digital ledger server 120. When digital ledger server 120 receives an allocation request from first user device 124, digital ledger server 120 may verify the authenticity of the request using the private key generated for first user device 124 to decrypt the request. Alternatively, if the first allocation request is not encrypted, digital ledger server 120 can authenticate the request using user credentials, a hardware fingerprint of the first user device (e.g., as obtained from communications received from the first user device), a token, a one-time code, another device, and/or the like. Digital ledger server 120 may then encrypt subsequent communications to first user device 124 using the public key provided by first user device 124. During a transaction, digital ledger server 120 may receive the private key associated with a transaction node that is to be allocated to a new device to allow digital ledger server 120 to facilitate the transaction. To complete the allocation request from first user device 124, first user device 124 may decrypt package of data 112 and notify ledger management block 144.

In some instances, the digital ledger server 120 may facilitate transactions by decrypting allocation nodes 148 or information stored therein. When a transaction is requested, digital ledger server 120, via creation block 116, may generate a new allocation node 108 using the data of the original allocation node 104 (e.g., as encrypted). The modifications to the package of data 112 may be provided as data and instructions that may be implemented when the transaction completes. Once the new allocation node 108 is generated and linked to the original allocation node 104, digital ledger server 120 may facilitate transfer of the private key associated with the original transaction node 104 to the second user device 128 that is to receive the digital objects of the original transaction to enable the second user device 128 the ability to decrypt the allocation node corresponding to the received digital objects. Second user device 128 may decrypt the package of data 112 of the new allocation node 108 using the received private key causing the modification to the package of data 112 to be implemented. The second user device 128 may then re-encrypt the package of data 112 using a public key of the second user device 128 and transmit the encrypted package of data 112 back to digital ledger server 120 along with a proof-of-work token that authenticates the modified package of data.

In other instances, the first user device 124 may transmit the private key usable to decrypt information associated with the first user device 124 (e.g., the first transaction node, etc.) to digital ledger server 120. Digital ledger server 120 may use the private key to execute the transaction and generate the new allocation node 108. Digital ledger server 120 may then encrypt the new allocation node using a public key of second user device 128.

Ledger management block 144 may obtain package of data 112 from node 104, which may be used by creation block 116 to generate a new allocation node (e.g., allocation node 108). Ledger management block 144 may manage digital ledger 152 including managing allocation nodes (e.g., generating new allocation nodes, maintaining the persistence of data stored within allocation nodes, etc.), generating new allocation nodes, linking allocation nodes to represent allocations of digital objects, etc.

Allocation nodes 148 may be represented by digital ledger 152. Nodes may be connected to each other in one way or bi-directionally to represent a transaction. For example, a first allocation node that allocates digital objects to a second allocation node may be connected by a directed connection between the first allocation node to the second allocation node. In that example, digital ledger 152 may represent the nodes as a directed graph in which each transaction is represented by a transfer of some or all of the digital objects of a first allocation node to one or more connected allocation nodes. In some instances, digital ledger 152 may represent the nodes as a directed acyclic graph (DAG) in which the blocks do not result in cycles (e.g., a first node may be connected to one or more nodes that will not connect be connected to the first node directly or through one or more additional nodes). In other instance, a first node may be connected to a second node using a bidirectional connection that enables information from the first node to remain with the digital object allocated to the second node.

Ledger management block 144 may include one or more proof-of-work algorithms and/or one or more proof-of-stake algorithms to further secure each allocation node and prevent fraudulent transactions from transferring digital objects to other devices. The proof-of-work and/or proof-of-stake algorithms may be implemented in a manner to accommodate a centralized or decentralized network. The digital ledger server 120 may validate the transactions through an algorithmic and/or scoring process after a pre-determined duration and/or number of allocation nodes are created. Digital ledger 152 may be permissioned (e.g., in which each device may be authorized to execute particular requests) or permissionless. New nodes can be generated by transferring a package of data from a first node, modifying the package of data based on data factors, storing the modified package of data within the new node, and encrypting the new node using the cryptographic algorithm. A reference to the new allocation node may then be transmitted to a device associated with the new node (e.g., a device operated by a user that is to have access to the digital objects of the new allocation node).

Ledger management block 144 may maintain associations between nodes and user devices. Digital ledger server 120, via creation block 116, can obtain information from internal and external sources to create one or more data factors usable to modify package of data 112 and create second allocation node 108 associated with second user device 128. Creation block 116 may utilize package of data 112 as an internal source. Dominant or recessive characteristics may be associated with package of data 112 and may be utilized by creation block 116 to modify package of data 112. Machine-learning block 156 may generate supplemental data factors to be utilized in conjunction with the one or more data factors generated from internal and external sources. Creation block 116 may receive input from external devices such as object distribution services 136, mobile devices 140, etc. An object distribution service may include one or more terminal devices (e.g., computing devices, mobile devices, servers, databases, point-of-sale devices, etc.) of a third party configured to facilitate the distribution of objects or services. Examples of object distribution services 136 include but is not limited to, retail stores, websites, businesses, and/or the like. Object distribution services 136 may output data to creation block 116 that generate additional data factors for creation block 116 to utilize when modifying package of data 112. For example, an object distribution service 136 may provide a gift with purchase special, a bonus digital object, or the like.

In some instances, creation block 116 may receive information from other external sources, like mobile device 140. Mobile device 140 can be a smartphone, webserver, user device, and/or the like. Creation block 116 may use the data received from mobile device 140 and/or other external sources to generate or supplement the data factors used to modify package of data 112. Creation block 116 may also receive information contained in individual data bundle 132 associated with second user device 128. Individual data bundle 132 may include or be stored within a digital wallet within local memory of second user device 128. Individual data bundle 132 may be include digital objects allocated by digital ledger server 120 to a digital wallet associated with a user device. Individual data bundle 132 may contain individual packages of data 112 that are associated with dominant or recessive characteristics.

Digital ledger server 120 may facilitate a connection between first allocation node 104 and second allocation node 108. Digital ledger server 120 may transmit a notification to second user device 128 including a reference to allocation node 108 and package of data 112 modified by creation block 116. Digital ledger server 120 may encrypt package of data 112 modified by creation block 116 with a public key associated with second user device 128. The reference may be stored in a digital wallet within local memory of second user device 128 along with one or more cryptographic keys (e.g., a private key associated with second user device 128) that enable access to allocation node 108 and the corresponding digital object. The digital wallet within the local memory of second user device 128 may be comprised of individual data bundle 132. Digital ledger server 120 may then transmit a notification to first user device 124 indicating a successful allocation of the digital object to second user device 128 and updating of the digital wallet.

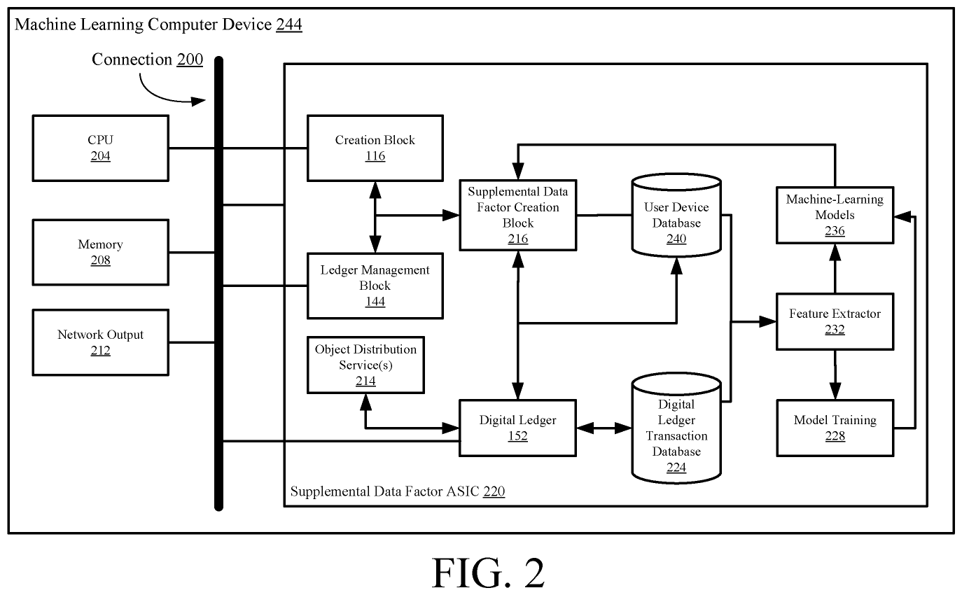

FIG. 2 illustrates an example computer device configured to conduct machine-learning modeling and training according to aspects of the present disclosure. Machine-learning computer device 244 may be a component of or included within digital ledger server 120. Machine-learning computer device 244 may be comprised of hardware components CPU 204, memory 208, network output 212, supplemental data factor application-specific integrated circuit (ASIC) 220, any combination thereof, and the like. The components of machine-learning computer device 244 are shown in electrical communication with each other using connection 200, such as a bus. Memory 208 may include multiple types of homogenous or heterogenous memory (e.g., such as, but not limited to, magnetic, optical, solid state, etc.). Machine-learning computer device 244 may include one or more network output 212 components (e.g., devices, ASICs, FPGAs, software, combinations thereof, and/or the like) that output data to digital ledger server 120.

Machine-learning computer device 244 may also include supplemental data factor ASIC 220. Supplemental data factor ASIC 220 may be electrically connected to CPU 204, memory 208, and network output 212 by connection 200. Supplemental data factor ASIC 220 may be an integrated circuit containing a number of additional hardware elements, including hardware implementations of various elements discussed in FIG. 1 above and in the following figures below, including, but not limited to, creation block 116, ledger management block 144, digital ledger 152, etc. Although the aforementioned elements will be discussed in a hardware context, they are also applicable in a software context.

Supplemental data factor ASIC 220 may utilize machine learning and artificial intelligence to generate supplemental data factors to use to modify package of data 112. Machine-learning models 236 may be a classifier (e.g., configured to classify a predicted future processing load according to discrete categories such as, but not limited to, a support vector machine, Naïve Bayes, K-nearest neighbors, neural networks, decision trees, etc.), a clustering-based model (e.g., neural network or other model using K-means, density-based spatial clustering of applications with noise, random forest, a gaussian mixture model, balance iterative reducing and clustering using hierarchies, affinity propagation, mean-shift, ordering points to identify the clustering structure, agglomerative hierarchy, spectral clustering, or the like), and/or the like. In some instances, machine-learning models 236 may include one or more ensemble models (of one or more machine-learning models).

Feature extractor 232 may receive information from user device database 240 (e.g., information associated with user devices that are similarly situated to first user device 124 and/or second user device 128, including, but not limited to, socioeconomic data, gender, race, preferences, interests, etc.) and/or from digital ledger transaction database 224 (e.g., such as information associated with past transactions conducted on digital ledger 152, including, but not limited to, object distribution services 214, user devices, etc.). User device database 240 may contain data pertaining to user devices that have transmitted, received, or otherwise been affiliated with, transactions on digital ledger 152. User device database may store data including, but not limited to, demographic information of user device, location of user device, historical activity of user device, any combination thereof, and the like. Machine-learning models 236 utilizes this data to generate factors relevant to first user device 124 or second user device 128 by recognizing similarly situated user devices within the user device database.

Feature extractor 232 may define one or more feature vectors for machine-learning models 236 for training and regular operations. Model training 228 may direct feature extractor 232 to define feature vectors that include features from both resources database 240 and historical resource allocation database 224. The feature vectors may be aggregated into training datasets usable to train machine-learning models 236.

Machine-learning models 236 may be trained using supervised learning, unsupervised learning, semi-supervised learning, reinforcement learning, a combination thereof, or the like. the type of training may be selected based on a particular model to be trained and whether a training feature vector includes labels (e.g., for supervised learning). For example, a classifier such as a support vector machine can be trained using a combination of supervised learning and reinforcement learning. Model training 228 may training machine-learning models 236 for a predetermined time interval, over a predetermined quantity of iterations, until one or more accuracy metrics are reached (e.g., such as, but not limited to, accuracy, precision, area under the curve, logarithmic loss, F1 score, mean absolute error, mean square error, etc.), and/or the like. Once trained, model training 228 may continue to monitor accuracy metrics and/or other metrics of machine-learning models 236 (e.g., in real time or each time machine-learning models 236 generates a prediction or output, etc.). Machine-learning models 236 may be continually trained using reinforcement learning in regular intervals, upon detecting an event (e.g., such as when an accuracy metric falls below a threshold, a particular prediction or output, a confidence value, etc.), or the like. In some instances, model training 228 may determine to instantiate a new machine-learning model 236 based on the one or more accuracy metrics (e.g., such as when one or more accuracy metrics fall below a threshold, etc.).

Once machine-learning models 236 are trained, feature extractor 232 may generate feature vectors using user device database 240 and digital ledger transaction database 224. The feature vector may be passed as input into machine-learning models 236 to generate data relevant to a specific user. The relevant data may be passed to supplemental data factor creation block 216. Supplemental data factor creation block 216 may generate one or more supplemental data factors to be used in conjunction with data factors generated by creation block 116. Supplemental data factor creation block 216 may transmit the supplemental data factors to creation block 116 and ledger management block 144. Creation block 116 may utilize the supplemental data factors when modifying package of data 112.

The hardware implementation of ledger management block 144 may exchange data with supplemental data factor creation block 216, including, but not limited to, demographic data of user devices, characteristics of user devices, information associated with package of data 112, information associated with object distribution service 214 associated with package of data 112, any combination thereof, and the like. The hardware implementation of digital ledger 152 may exchange data with supplemental data factor creation block 216, including, but not limited to, historical transactions on the digital ledger involving associated object distribution services 214, user devices, any combination thereof, and the like.

In some instances, a ledger report may be requested regarding the transactions recorded and managed by ledger management block 144. The ledger report may be utilized by an individual associated with the digital ledger, including, but not limited to, administrators, management, third-party, object distribution service 214, IT, and/or users. The hardware implementation of ledger management block 144 may generate a report including, but not limited to, demographic data of user devices, characteristics of user devices, information associated with package of data 112, information associated with object distribution service 214 associated with package of data 112, historical transactions on the digital ledger involving associated object distribution services 214, historical transactions on the digital ledger involving allocated packages of data, user devices, any combination thereof, and the like.

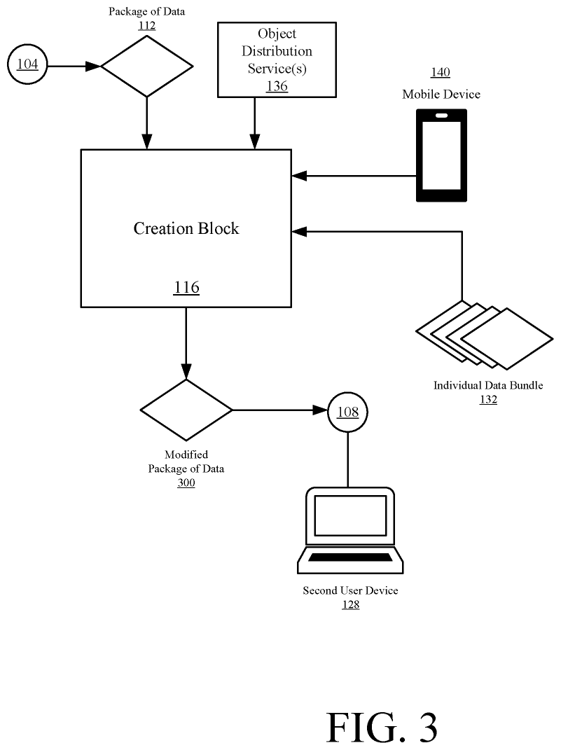

FIG. 3 illustrates an example system configured to personalize a package of data for a particular user according to aspects of the present disclosure. Creation block 116 may receive package of data 112 associated with the digital object from ledger management block 144. Creation block 116 may obtain information from internal and external sources to create one or more data factors usable to modify package of data 112, creating modified package of data 300, and create second allocation node 108 associated with second user device 128 via ledger management block 144.

Creation block 116 may receive input from ledger management block 144 (e.g., package of data 112, individual data bundle 132 associated with the second user device 128, machine-learning block 156, and/or other internal sources, combinations thereof, or the like). Individual data bundle 132 may include or be stored within a digital wallet within local memory of second user device 128. Individual data bundle 132 may be comprised of references to packages of data associated with non-fungible objects allocated by digital ledger server 120 to a digital wallet associated with a user device. Creation block 116, using data from the internal sources, generates a set of data factors that can be used to generate modified package of data 300. Creation block 116 may modify package of data 112 based on internal factors, which may be particular to that respective transaction. Examples of internal factors include, but are not limited to, items in the digital wallet associated with the first or second user device, geographic location of first or second user device, combinations thereof, or the like.

Creation block 116 may receive input from external devices such as object distribution services 136, mobile devices 140, etc. Examples of object distribution services 136 include but are not limited to, retail stores, websites, businesses, and/or the like. Object distribution services 136 may output data to creation block 116 that generates additional data factors for creation block 116 to utilize when modifying package of data 112. For example, an object distribution service 136 may provide a gift with purchase special, a bonus digital object, or the like.

In some instances, creation block 116 may receive information from other external sources, like mobile device 140. Mobile device 140 can be a smartphone, webserver, user device, and/or the like. Creation block 116 may use the data received from mobile device 140 and/or other external sources to generate or supplement the data factors used to modify package of data 112.

Object distribution service 136 may be a third-party retailer that provides objects and/or services. The third-party retailer may provide a bonus digital object to user devices. A user device may receive an additional digital object when the user device acquires three non-fungible objects associated with the third-party retailer. If individual data bundle 132 includes package of a data 112, which may be associated with the third-party retailer and two additional packages of data associated with the same third-party retailer (i.e., three non-fungible objects associated with the same digital retailer), then creation block 116 may receive input from the third-party retailer pertaining to the bonus digital object. Creation block 116 may modify package of data 112 to contain the bonus digital object provided by the third-party retailer, creating a modified package of data 300 that contains references to an additional digital object.

After the modified package of data 300 is generated by creation block 116, digital ledger server 120 may generate allocation node 108 and store modified package of data 300. Digital ledger server 120 may transmit a notification to second user device 128 including a reference to allocation node 108 and modified package of data 300. Digital ledger server 120 may encrypt modified package of data 300 with a public key associated with second user device 128.

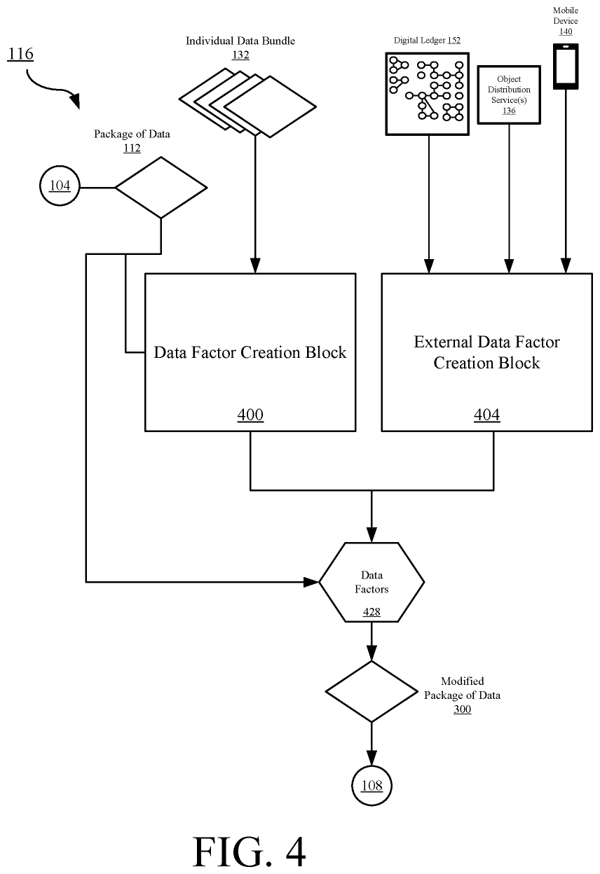

FIG. 4 illustrates an example system configured to execute a personalization process using internal and external data according to aspects of the present disclosure within creation block 116. Creation block 116 may contain at least two operations to create data factors 428, including, but not limited to, data factor creation block 400 and external data factor creation block 404. Data factor creation block 400 and external data factor creation block 404 may obtain information from internal and external sources to create one or more data factors usable to modify package of data 112 (generating modified package of data 300) and create second allocation node 108 associated with second user device 128.

Data factor creation block 400 may receive input from ledger management block 144 (e.g., package of data 112, individual data bundle 132 associated with the second user device 128, machine-learning block 156, and/or other internal sources). Data factor creation block 400, using data from the internal sources, generates a set of data factors 428 that are used to generate modified package of data 300. Data factor creation block 400 may modify package of data 112 based on internal factors, which may be particular to that respective transaction. Examples of internal factors include, but are not limited to, items in the digital wallet associated with the first or second user device, geographic location of first or second user device, combinations thereof, or the like.

Data factor creation block 400 may receive input pertaining to individual data bundle 132 associated with second user device 128. Individual data bundle 132 may include or be stored within a digital wallet within local memory of second user device 128. Individual data bundle 132 may be comprised of references to packages of data associated with digital objects allocated by digital ledger server 120 to a digital wallet associated with a user device. Data factor creation block 400 may request data from individual data bundle 132 about the individual digital objects within individual data bundle 132, including, but not limited to, a value of the digital objects, terminal devices and/or object distribution services 136 associated with digital objects within the individual data bundle 132, how frequently digital objects are inputted and outputted from individual data bundle 132, any combination thereof, and the like. Data factor creation block 400 may use the aforementioned data from individual data bundle 132 to generate data factors 428 utilized to modify package of data 112 and generate modified package of data 300.

Data factor creation block 400 may receive input pertaining to package of data 112. Data factor creation block 400 may request information about package of data 112, including, but not limited to, the value of the digital object associated with package of data 112, terminal device or object distribution service(s) 136 associated with package of data 112, date of creation of the digital object associated with the package of data 112, any combination thereof, and the like.

External data factor creation block 404 may receive input from one or more external factors. Examples of external factors include, but are not limited to, an identification of a quantity of permitted transactions involving the digital object, additional value or properties to be added to the digital object during a transaction, value or properties to be removed from the digital object during a transaction, value or properties of the digital object that are to be modified during a transaction, additional digital objects to be allocated to the first user device and/or the second user device during a transaction, combinations thereof, or the like.

External data factor creation block 404 may receive input from digital ledger 152. The input can be pertaining to the digital object, a terminal device associated with the digital object, first user device 124 and/or second user device 128, any combination thereof, and the like. Digital ledger 152 may keep a historical record of all transactions occurring over a duration of time and store that historical record in local memory, which may be passed as input to external data factor creation block 404. For example, this data may include the number of transactions involving the digital object, the number of digital objects in circulation that are associated with the terminal device, the number of times second user device 128 has reallocated a digital object, any combination thereof, and the like. External data factor creation block 404 may utilize this data from the digital ledger 152 to create data factors to modify the package of data 112.

External data factor creation block 404 may receive input from object distribution service 136. The input may be pertaining to the nature of the digital object and the associated terminal device. Examples of object distribution services 136 include but is not limited to, retail stores, websites, businesses, and/or the like. Object distribution services 136 may output data to external data factor creation block 404 that generate additional data factors for creation block 116 to utilize when modifying package of data 112. For example, an object distribution service 136 may provide a gift with purchase special, a bonus digital object, or the like.

In some instances, creation block 116 may receive information from other external sources, like mobile device 140. Mobile device 140 can be a smartphone, webserver, user device, and/or the like. Creation block 116 may use the data received from mobile device 140 and/or other external sources to generate or supplement the data factors used to modify package of data 112. Creation block 116 may also receive information contained in individual data bundle 132 associated with second user device 128. Individual data bundle 132 may include or be stored within a digital wallet within local memory of second user device 128. Individual data bundle 132 may be comprised of references to packages of data associated with digital objects allocated by digital ledger server 120 to a digital wallet associated with a user device.

Creation block 116 may generate data factors 428 utilizing the data factors generated by both data factor creation block 400 and external data factor creation block 404. The incorporation of data from both internal sources and external sources may generate a unique set of data factors 428 that are customized to package of data 112. Creation block 116 can ensure that the digital objects exchanged on digital ledger 152 are personalized based on the individual user device involved in the transaction thereby producing near unique digital objects. Since each digital object is modified during each transaction, the likelihood that a digital object is identical to another digital object is reduced with each subsequent transaction.

Modified package of data 300 may be the result of package of data 112 combined with data factors 428. Creation block 116 may use a creation algorithm to modify package of data 112 according to data factors 428 generated by data factor creation block 400 and external data factor creation block 404. Modified package of data 300 may contain all the data from package of data 112 and additional data added by the creation algorithm of creation block 116.

After the modified package of data 300 is generated by creation block 116, digital ledger server 120 may generate allocation node 108 and store modified package of data 300. Digital ledger server 120 may transmit a notification to second user device 128 including a reference to allocation node 108 and modified package of data 300. Digital ledger server 120 may encrypt modified package of data 300 with a public key associated with second user device 128.

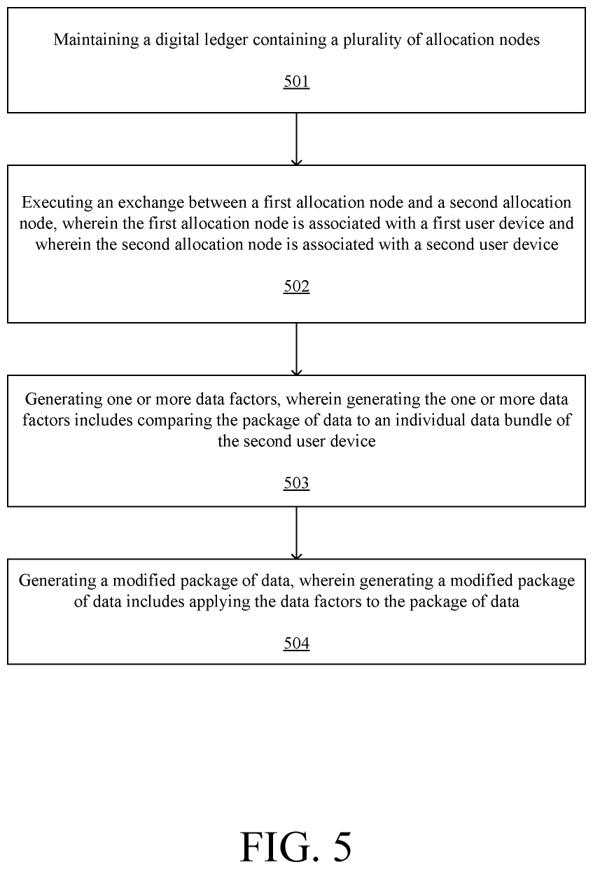

FIG. 5 illustrates a flowchart of an example process for generating a modified package of data according to aspects of the present disclosure. At block 501, a computing device may maintain a digital ledger containing a plurality of allocation nodes. The computing device may be, but is not limited to, a desktop or laptop computer, a server (e.g., such as digital ledger server 120 as previously described), a mobile device (e.g., such as a smartphone, tablet, etc.), or any other processing device configured to execute instructions. The computing device may include a digital ledger configured to record and manage digital objects associated with a plurality of user devices and/or terminal devices. A transaction can be executed between a first user device and a second user device (e.g., such as first user device 124 and second user device 128 as previously described) that allocates a digital object of the first user device to the second user device. The first user device and the second user device can be, but is not limited to, a mobile phone, desktop, smart watch, or other device. The first user device and the second user device can be associated with the same user. The first user device and the second user device may be connected to a digital ledger server by one or more network processors (e.g., WiFi, Bluetooth, and/or other transceivers). The digital ledger server may be hosted on a computing device that may contain one or more processing devices, including, but not limited to, system-on-a-chip, central processing units, application-specific integrated circuits, field programmable gate arrays, and/or the like.

A ledger management block may maintain the digital ledger by coordinating transactions of digital objects between user devices. The ledger management block uses digital objects to generate a dataset to be stored in an allocation node on the digital ledger. Each allocation node of the digital ledger may be generated by organizing the dataset to be stored in the transaction block (e.g., into a set of data, vector, and/or the like) and encrypting the dataset using a cryptographic algorithm (e.g., such as a hash algorithm 3 (SHA-3) that generates 256-bit or greater hashes). The cryptographic algorithm may contain a public key generated by a private key associated with a user device. The private key is maintained in a digital wallet within local memory of the user device.

A private key may be comprised of a 256-bit or more hash. A private key may be generated by the associated user device or generated by a secondary device and/or secondary algorithm. The private key is used to generate a public key with an elliptic curve digital signal algorithm (ECDSA). The public key is used to encrypt packages of data associated with an allocation node using an RSA cryptosystem. The digital ledger server may use the public key associated with the user device when allocating digital objects to the user device.

The ledger management block may manage the digital ledger including managing allocation nodes (e.g., generating new allocation nodes, maintaining the persistence of data stored within allocation nodes, etc.), generating new allocation nodes, linking allocation nodes to represent allocations of digital objects, etc. Allocation nodes may be represented by the digital ledger. Nodes may be connected to each other in one way or bi-directionally to represent a transaction. For example, a first node that allocates digital objects to a second allocation node may be connected by a directed connection between the first allocation node to the second allocation node. In that example, digital ledger may represent the nodes as a directed graph in which each transaction is represented by a transfer of some or all of the digital objects of a first allocation node to one or more connected allocation nodes. In some instances, digital ledger may represent the nodes as a directed acyclic graph (DAG) in which the blocks do not result in cycles (e.g., a first node may be connected to one or more nodes that will not connect be connected to the first node directly or through one or more additional nodes). In other instance, a first node may be connected to a second node using a bidirectional connection that enables information from the first node to remain with the digital object allocated to the second node.

The ledger management block may include one or more proof-of-work algorithms and/or one or more proof-of-stake algorithms to further secure each allocation node and prevent fraudulent transactions from transferring digital objects to other devices. The proof-of-work and/or proof-of-stake algorithms may be implemented in a manner to accommodate a centralized or decentralized network. The digital ledger server may validate the transactions through an algorithmic and/or scoring process after a pre-determined duration and/or number of allocation nodes are created. Digital ledger may be permissioned (e.g., in which each device may be authorized to execute particular requests) or permissionless. New nodes can be generated by transferring a package of data from a first node, modifying the package of data based on data factors, storing the modified package of data within the new node, and encrypting the new node using the cryptographic algorithm. A reference to the new allocation node may then be transmitted to a device associated with the new node (e.g., a device operated by a user that is to have access to the digital objects of the new allocation node).

At block 502, in which digital ledger server may execute an exchange between a first allocation node and a second allocation node. The first allocation node is associated with a first user device and wherein the second allocation node is associated with a second user device. The first user device may transmit a request to the digital ledger server to allocate a digital object. For example, the first user device may request to allocate the digital object to an object distribution service in exchange for one or more objects provided by or services performed by the object distribution service or an associated device. In another example, the first user device may transmit a request to allocate the digital object to the second user device. The ledger management block may obtain package of data associated with the digital object from a first allocation node (e.g., allocation node 104 previously mentioned), which may be used by the creation block to generate a second allocation node (e.g., allocation node 108 previously mentioned). The ledger management block may facilitate a connection between the first allocation node and the second allocation node, then records the allocation of the digital object to the second user device along with any modifications to the digital object that result from the allocation.

The ledger management block may then transmit a notification to the second user device indicating that the digital object has been allocated to the second user device from the first user device as modified by the digital ledger server. The notification may include additional information along with the indication that the digital object has been allocated to the second user device such as, but not limited to, encryption keys usable to access the digital object or execute functions of the digital ledger on the digital object, information associated with the digital object, metadata, information associated with the first user device, information associated with the third-party and/or source of the digital object, combinations thereof, or the like. The notification and/or any information included therein may be stored in a digital wallet within local memory of the second user device. The ledger management block may transmit a notification to the first user device indicating a successful allocation of the digital object. The notification may cause the digital wallet of the first user device to be updated by removing a reference to the digital object and any access keys to the first allocation node of the digital ledger.

At block 503, the digital ledger server may generate one or more data factors. Generating the one or more data factors includes comparing the package of data to an individual data bundle of the second user device. Data factors may be generated within the creation block. The creation block may receive input from the ledger management block (e.g., package of data, individual data bundle associated with the second user device, and/or other internal sources). The creation block, using data from the internal sources, generates a series of data factors that are used to generate a modified package of data. In some instances, the digital ledger server may modify digital objects based on internal factors, which may be particular to that respective transaction.

Examples of internal factors include, but are not limited to, items in the digital wallet associated with the first user device or the second user device (e.g., individual data bundle 132), geographic location of the first user device or the second user device, combinations thereof, or the like. The digital ledger server may modify digital objects to reduce the quantity of nodes within the digital ledger, reduce duplicity, and/or decrease waste. For example, if the digital wallet associated with the second user device includes references to a pre-existing digital object associated with a terminal device, any additional digital objects allocated to the second user device also associated with the terminal device may be combined with the pre-existing digital object to generate a unified digital object. For another example, a user device could be allocated a digital object associated with a specific object (i.e., a video game) but, after any duration of time, be allocated a second digital object also associated with that specific object. Upon receipt of the second digital object by the user device, the creation block may generate, using external and internal factors, various alternatives to the specific item to avoid duplicity within the digital wallet associated with the user device. The algorithm for digital object modification may utilize particular properties of the digital object or user device.

The creation block may receive input pertaining to the individual data bundle associated with the second user device. The individual data bundle may include or be stored within a digital wallet within local memory of the second user device. The individual data bundle may be comprised of references to packages of data associated with digital objects allocated by the digital ledger server to a digital wallet associated with a user device. The digital objects within the individual data bundle associated with the second user device may be associated with dominant or recessive characteristics. The creation block may request data from the individual data bundle about the individual digital objects within the individual data bundle, including, but not limited to, number of digital objects, terminal devices and/or object distribution services associated with digital objects within the individual data bundle, how frequently digital objects are inputted and outputted from the individual data bundle, dominant or recessive characteristics of the digital objects, any combination thereof, and the like. The creation block may use the aforementioned data from the individual data bundle to generate data factors utilized to modify package of data and generate a modified package of data.

The creation block may receive input pertaining to the package of data. The creation block may request information about the package of data, including, but not limited to, the value of the digital object associated with the package of data, terminal device or object distribution service(s) associated with the package of data, whether the package of data is associated with dominant or recessive characteristics, date of creation of the digital object associated with the package of data, any combination thereof, and the like.

At block 504, where the digital ledger server may generate a modified package of data. Generating a modified package of data includes applying the data factors to the package of data. The creation block may generate data factors utilizing the data factors generated by both internal and external sources (e.g., generated by data factor creation block 400 and external data factor creation block 404 previously mentioned). The creation block can ensure that the digital objects exchanged on the digital ledger are personalized based on the individual user device involved in the transaction thereby producing near unique digital objects. Since each digital object is modified during each transaction, the likelihood that a digital object is identical to another digital object is reduced with each subsequent transaction.

The modified package of data may be the result of the package of data combined with data factors. The creation block may use a creation algorithm to modify the package of data according to data factors generated by the creation block. The modified package of data may contain all the data from the package of data and additional data inputted by the creation algorithm of the creation block. The modified package of data may contain some of the data from the package of data and additional data inputted by the creation algorithm of the creation block.

After the modified package of data is generated by the creation block, the digital ledger server may generate an allocation node and store the modified package of data. The digital ledger server may transmit a notification to the second user device including a reference to the new allocation node and the modified package of data. The digital ledger server may encrypt the modified package of data with a public key associated with the second user device.

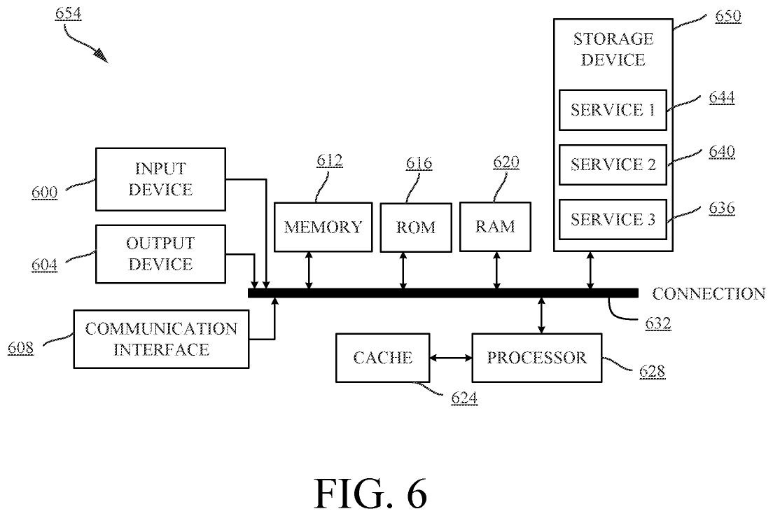

FIG. 6 illustrates an example computing device according to aspects of the present disclosure. For example, computing device 654 can implement any of the systems or methods described herein. In some instances, computing device 654 may be a component of or included within a media device. The components of computing device 654 are shown in electrical communication with each other using connection 632, such as a bus. The example computing device architecture 654 includes a processor (e.g., CPU, processor, or the like) 628 and connection 632 (e.g., such as a bus, or the like) that is configured to couple components of computing device 654 such as, but not limited to, memory 612, read only memory (ROM) 616, random access memory (RAM) 620, and/or storage device 650, to processing unit 628.

Computing device 654 can include a cache 624 of high-speed memory connected directly with, in close proximity to, or integrated within processor 628. Computing device 654 can copy data from memory 612 and/or storage device 650 to cache 624 for quicker access by processor 628. In this way, cache 624 may provide a performance boost that avoids delays while processor 628 waits for data. Alternatively, processor 628 may access data directly from memory 612, ROM 616, RAM 620, and/or storage device 650. Memory 612 can include multiple types of homogenous or heterogeneous memory (e.g., such as, but not limited to, magnetic, optical, solid-state, etc.).

Storage device 650 may include one or more non-transitory computer-readable media such as volatile and/or non-volatile memories. A non-transitory computer-readable medium can store instructions and/or data accessible by computing device 654. Non-transitory computer-readable media can include, but is not limited to magnetic cassettes, hard-disk drives (HDD), flash memory, solid state memory devices, digital versatile disks, cartridges, compact discs, random access memories (RAMs) 620, read only memory (ROM) 612, combinations thereof, or the like.

Storage device 650, may store one or more services, such as service 1 644, service 2 640, and service 3 636, that are executable by processor 628 and/or other electronic hardware. The one or more services include instructions executable by processor 628 to: perform operations such as any of the techniques, steps, processes, blocks, and/or operations described herein; control the operations of a device in communication with computing device 654; control the operations of processing unit 628 and/or any special-purpose processors; combinations therefor; or the like. Processor 628 may be a system on a chip (SOC) that includes one or more cores or processors, a bus, memories, clock, memory controller, cache, other processor components, and/or the like. A multi-core processor may be symmetric or asymmetric.

Computing device 654 may include one or more input devices 600 that may represent any number of input mechanisms, such as a microphone, a touch-sensitive screen for graphical input, keyboard, mouse, motion input, speech, media devices, sensors, combinations thereof, or the like. Computing device 654 may include one or more output devices 604 that output data to a user. Such output devices 604 may include, but are not limited to, a media device, projector, television, speakers, combinations thereof, or the like. In some instances, multimodal computing devices can enable a user to provide multiple types of input to communicate with computing device 654. Communications interface 608 may be configured to manage user input and computing device output. Communications interface 608 may also be configured to managing communications with remote devices (e.g., establishing connection, receiving/transmitting communications, etc.) over one or more communication protocols and/or over one or more communication media (e.g., wired, wireless, etc.).

Computing device 654 is not limited to the components as shown in FIG. 6. Computing device 654 may include other components not shown and/or components shown may be omitted.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored in a form that excludes carrier waves and/or electronic signals. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Some portions of this description describe examples in terms of algorithms and symbolic representations of operations on information. These operations, while described functionally, computationally, or logically, may be implemented by computer programs or equivalent electrical circuits, microcode, or the like. Furthermore, arrangements of operations may be referred to as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some examples, a software module can be implemented with a computer-readable medium storing computer program code, which can be executed by a processor for performing any or all of the steps, operations, or processes described.

Some examples may relate to an apparatus or system for performing any or all of the steps, operations, or processes described. The apparatus or system may be specially constructed for the required purposes, and/or it may comprise a general-purpose computing device selectively activated or reconfigured by a computer program stored in memory of computing device. The memory may be or include a non-transitory, tangible computer readable storage medium, or any type of media suitable for storing electronic instructions, which may be coupled to a bus. Furthermore, any computing systems referred to in the specification may include a single processor or multiple processors.

While the present subject matter has been described in detail with respect to specific examples, it will be appreciated that those skilled in the art, upon attaining an understanding of the foregoing, may readily produce alterations to, variations of, and equivalents to such embodiments. Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter. Accordingly, the present disclosure has been presented for purposes of example rather than limitation, and does not preclude the inclusion of such modifications, variations, and/or additions to the present subject matter as would be readily apparent to one of ordinary skill in the art.

For clarity of explanation, in some instances the present disclosure may be presented as including individual functional blocks including functional blocks comprising devices, device components, steps or routines in a method embodied in software, or combinations of hardware and software. Additional functional blocks may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Individual examples may be described herein as a process or method which may be depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but may have additional steps not shown. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

Devices implementing the methods and systems described herein can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. The program code may be executed by a processor, which may include one or more processors, such as, but not limited to, one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A processor may be a microprocessor; conventional processor, controller, microcontroller, state machine, or the like. A processor may also be implemented as a combination of computing components (e.g., a combination of a DSP and a microprocessor, a plurality of microprocessors, one or more microprocessors in conjunction with a DSP core, or any other such configuration). Accordingly, the term “processor,” as used herein may refer to any of the foregoing structure, any combination of the foregoing structure, or any other structure or apparatus suitable for implementation of the techniques described herein. Functionality described herein also can be embodied in peripherals or add-in cards. Such functionality can also be implemented on a circuit board among different chips or different processes executing in a single device, by way of further example.

In the foregoing description, aspects of the disclosure are described with reference to specific examples thereof, but those skilled in the art will recognize that the disclosure is not limited thereto. Thus, while illustrative examples of the disclosure have been described in detail herein, it is to be understood that the inventive concepts may be otherwise variously embodied and employed, and that the appended claims are intended to be construed to include such variations. Various features and aspects of the above-described disclosure may be used individually or in any combination. Further, examples can be utilized in any number of environments and applications beyond those described herein without departing from the broader spirit and scope of the disclosure. The disclosure and figures are, accordingly, to be regarded as illustrative rather than restrictive.

The various illustrative logical blocks, modules, circuits, and algorithm steps described in connection with the embodiments disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or media devices of the computing platform. The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

1. A computer-implemented method, comprising:
maintaining a digital ledger containing a plurality of allocation nodes;
executing an exchange between a first allocation node and a second allocation node, wherein the first allocation node transfers ownership of a package of data to the second allocation node, and wherein the first allocation node is associated with a first user device and wherein the second allocation node is associated with a second user device;
generating one or more data factors, wherein generating the one or more data factors includes comparing the package of data to an individual data bundle of the second user device; and
generating a modified package of data, wherein generating a modified package of data includes applying the data factors to the package of data.

2. The computer-implemented method of claim 1, further comprising:
analyzing the individual data bundle of the second user device comprised of one or more packages of data; and
notifying a third party about characteristics of the individual data bundle of the second user device, including the modified package of data.

3. The computer-implemented method of claim 1, further comprising:
merging the modified package of data with a pre-existing package of data in the individual data bundle of the second allocation node.

4. The computer-implemented method of claim 1, further comprising:
adding an additional package of data to the individual data bundle of the second user device upon receipt of the modified package of data.

5. The computer-implemented method of claim 1, further comprising:
identifying one or more external data factors, wherein identifying the external data factors includes analyzing the digital ledger and the plurality of allocation nodes; and
updating the data factors to include the external data factors.

6. The computer-implemented method of claim 1, further comprising:
integrating the modified package of data and the individual data bundle of the second user device using the data factors, creating a personalized package of data.

7. The computer-implemented method of claim 1, further comprising:
receiving input from the second user device; and
modifying the modified package of data based on the input.

8. A system comprising:
one or more processors; and
a non-transitory computer-readable medium storing instructions that when executed by the one or more processors cause the one or more processors to perform operations including:
maintaining a digital ledger containing a plurality of allocation nodes;
executing an exchange between a first allocation node and a second allocation node, wherein the first allocation node transfers ownership of a package of data to the second allocation node, and wherein the first allocation node is associated with a first user device and wherein the second allocation node is associated with a second user device;
generating one or more data factors, wherein generating the one or more data factors includes comparing the package of data to an individual data bundle of the second user device; and
generating a modified package of data, wherein generating a modified package of data includes applying the data factors to the package of data.

9. The system of claim 8, further comprising:
analyzing the individual data bundle of the second user device comprised of one or more packages of data; and
notifying a third party about characteristics of the individual data bundle of the second user device, including the modified package of data.

10. The system of claim 8, further comprising:
merging the modified package of data with a pre-existing package of data in the individual data bundle of the second allocation node.

11. The system of claim 8, further comprising:
adding an additional package of data to the individual data bundle of the second user device upon receipt of the modified package of data.

12. The system of claim 8, further comprising:
identifying one or more external data factors, wherein identifying the external data factors includes analyzing the digital ledger and the plurality of allocation nodes; and
updating the data factors to include the external data factors.

13. The system of claim 8, further comprising:
integrating the modified package of data and the individual data bundle of the second user device using the data factors, creating a personalized package of data.

14. The system of claim 8, further comprising:
receiving input from the second user device; and
modifying the modified package of data based on the input.

15. A non-transitory computer-readable medium storing instructions that when executed by one or more processors cause the one or more processors to perform operations including:
maintaining a digital ledger containing a plurality of allocation nodes;
executing an exchange between a first allocation node and a second allocation node, wherein the first allocation node transfers ownership of a package of data to the second allocation node, and wherein the first allocation node is associated with a first user device and wherein the second allocation node is associated with a second user device;
generating one or more data factors, wherein generating the one or more data factors includes comparing the package of data to an individual data bundle of the second user device; and
generating a modified package of data, wherein generating a modified package of data includes applying the data factors to the package of data.

16. The non-transitory computer-readable medium of claim 15, wherein the operations further include:
analyzing the individual data bundle of the second user device comprised of one or more packages of data; and
notifying a third party about characteristics of the individual data bundle of the second user device, including the modified package of data.

17. The non-transitory computer-readable medium of claim 15, wherein the operations further include:
merging the modified package of data with a pre-existing package of data in the individual data bundle of the second allocation node.

18. The non-transitory computer-readable medium of claim 15, wherein the operations further include:
adding an additional package of data to the individual data bundle of the second user device upon receipt of the modified package of data.

19. The non-transitory computer-readable medium of claim 15, wherein the operations further include:
identifying one or more external data factors, wherein identifying the external data factors includes analyzing the digital ledger and the plurality of allocation nodes; and
updating the data factors to include the external data factors.

20. The non-transitory computer-readable medium of claim 15, wherein the operations further include:
integrating the modified package of data and the individual data bundle of the second user device using the data factors, creating a personalized package of data.
